(19) United States
(12) Patent Application Publication
(10) Pub. No.: US 2005/0260104 A1
(43) Pub. Date: Nov. 24, 2005

(54) Mounting apparatus

(76) Inventors: Robert Culbert, Manhattan Beach, CA (US); Trevor Lee Huston, Venice, FL (US)

Correspondence Address: SoCAL IP LAW GROUP LLP, 310 N. WESTLAKE BLVD. STE 120, WESTLAKE VILLAGE, CA, 91362, US

(21) Appl. No.: 10/849,073

(22) Filed: May 18, 2004

(51) Int. Cl. A62B 7/08

(52) U.S. Cl. 422/121

(57) ABSTRACT

There is disclosed a mounting apparatus for mounting a germicidal system in a vehicle. The germicidal system may comprise a lamp having a stem. The mounting apparatus may comprise a clasp for supporting the stem. The clasp may be adapted to affix to a member of a vehicle. The mounting apparatus may comprise a dampener for reducing an effect selected from the group comprising vibration and shock. The dampener may abut the clasp. The dampener may be adapted to abut the member of the vehicle.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

This present invention relates to mountings of mobile heat, ventilation, and air conditioning system systems.

2. Description of the Related Art

Modern vehicles have advanced suspensions which protect the body of the vehicle and the passenger cabin from forces and effects caused by road or ground irregularities, choppy waters, or turbulent air. However, even the best suspensions allow some bounce, pitch and roll to be transmitted beyond the suspension to the body and the passenger cabin.

Bounce refers to vertical motion or displacement. Bounce may occur when the vehicle rolls over a bump. Alternatively, bounce may occur when an aircraft is elevated by turbulence.

Pitch refers to rotational motion or rotational displacement about an axis perpendicular to the length of the vehicle. Pitch may also refer to motion forward and back with respect to the length of the vehicle. Pitch may occur when the vehicle accelerates or decelerates.

Roll refers to rotational motion or rotational displacement about an axis which is parallel to the length of the vehicle. Roll may also refer to motion side to side with respect to the length of the vehicle. Roll may occur when the vehicle makes a turn. Alternatively, roll may occur when heavy passengers move side to side within the vehicle.

A common suspension component of a ground vehicle is a strut assembly which includes a dashpot. A dashpot is a mechanical device which opposes motion and dissipates energy. Ideally, a dashpot applies a force opposing motion that is proportional to velocity.

### DESCRIPTION OF THE DRAWINGS

FIG. 1 is a cut-away rear perspective view of an HVAC system on a bus.

FIG. 2 is a partial perspective view of a first mounting apparatus.

FIG. 3 is a side view of a second mounting apparatus.

FIG. 4 is a partial perspective view of a third mounting apparatus.

FIG. 5 is a partial perspective view of a fourth mounting apparatus.

FIG. 6 is a partial perspective view of a fifth mounting apparatus.

FIG. 7 is a partial perspective view of a sixth mounting apparatus.

### DETAILED DESCRIPTION OF THE INVENTION

Today's vehicles have been outfitted with advanced creature comforts. Many vehicles now include heat, ventilation and air conditioning (HVAC) systems. One aspect of a modern HVAC system is the efficient control of air quality within the passenger cabin.

Efficiency is related to the amount of power required to perform HVAC functions, for example, heating, cooling, humidifying, dehumidifying, filtering, and sterilizing air that is transferred to and from the passenger cabin. As efficiencies are improved, the operating costs of the HVAC system and in turn, the vehicle are reduced. Moreover, since less energy is required to power efficient HVAC systems, less fuel is burned, resulting in lower emissions.

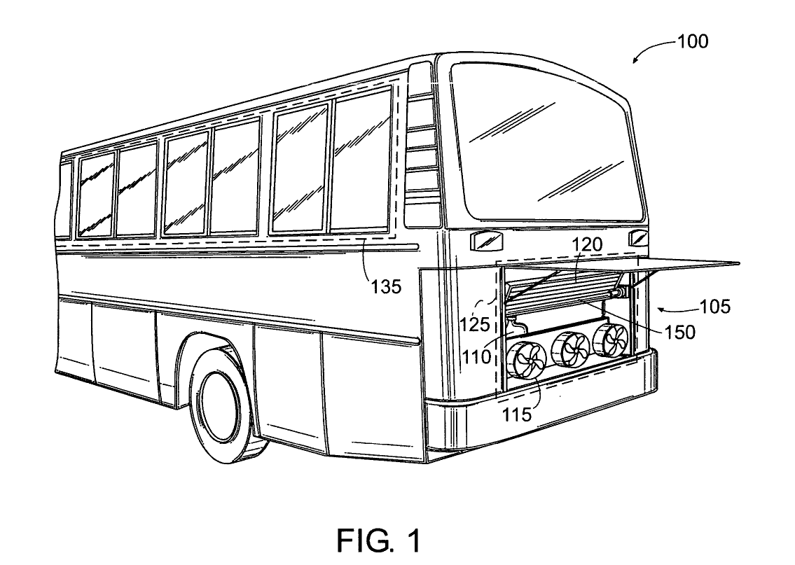

Referring now to FIG. 1, there is shown a cut-away rear perspective view of a vehicle 100. The vehicle 100 of FIG. 1 is a mass transit bus, one typically operated by a city or municipal transit authority. Alternatively, the vehicle 100 may be an airplane, a train, a taxi cab, a rail car, a boat, a trolley, a paratransit, a school bus, an ambulance, a police car, or a personal automobile. Installed in the vehicle 100 is an HVAC system 105. The HVAC system 105 may comprise an air duct 110, a fan 115, a heat exchanger 120, a filter 125, and a germicidal lamp 150. The air duct 110 may function as a conduit for moving air between the heat exchanger 120 and the passenger cabin 135 of the vehicle 100.

The heat exchanger 120 may function as an evaporator or a condenser. The heat exchanger 120 may comprise aluminum or copper fins. In an HVAC system, efficiency may be related to the surface area of all or part of the heat exchanger 120. During normal use, the heat exchanger 120 may accumulate undesirable organic and inorganic substances such as, but not limited to dirt, sediment from air pollution, grease, bacteria, viruses, molds, and microbes. When the heat exchanger 120 accumulates undesirable substances on its surface, it will not function at optimum efficiency because its effective surface area for heat transfer will be reduced. In contrast, cleaner surfaces of the heat exchanger 120 will transfer heat more efficiently. Some mass transit operators have estimated that heat exchanger 120 cleaning costs run approximately $500 to $1,000 per 60,000 miles of metro bus operation.

The fan 115 may comprise metal blades. Alternatively, the fan 115 may comprise composite material blades or plastic blades. The fan 115, when spinning, causes air to flow. The fan may cause the air to flow from the heat exchanger 120 to the passenger cabin 135 and/or from the passenger cabin 135 to the heat exchanger 120. Alternatively, the fan 115 may cause air to flow through the filter 125. The filter 125 is depicted with a broken line.

The efficiency of the fan 115 is related to the weight of the fan blades. The heavier the fan blades, the more power is required to turn the fan blades. The efficiency of the fan 115 is also related to the aerodynamics of the fan blades. The aerodynamics of the fan blade is related to the shape or geometry of the fan blade. The aerodynamics of the fan blade is also related to the surface smoothness of the blade itself. The smoother the surface of the fan blade, the less drag force the fan blade will be subject to. The less amount of drag, the less amount of power the fan 115 requires to turn the blades.

Similar to the heat exchanger 120, during normal operation, the fan 115 may accumulate undesirable organic and inorganic substances. When the fan 115 accumulates undesirable substances on the blades, it will not function at optimum efficiency because of increased weight and altered aerodynamics resulting in increased drag. Similar to the heat exchanger 120, mass transit operators have expended funds in periodically cleaning the surfaces of the fan blades to achieve more efficient operation.

A germicidal lamp 150 may be installed in a position to emit germicidal radiation on the heat exchanger 120 and/or the fan 115. The germicidal lamp 150 may enclose a vaporizable material such as mercury. The germicidal lamp 150 may emit ultraviolet light at a germicidal wavelength, for example 254 nm or 187 nm. The germicidal lamp 150 may emit at least one of or combinations of visual light, infrared light, and ultraviolet light.

Germicidal radiation helps retard accumulation of at least some undesirable substances on the heat exchanger 120 and/or the fan 115. Alternatively, or in combination, the germicidal lamp 150 may at least partially sterilize air and eliminate volatile organic compounds and/or odors that are processed via the HVAC system of the vehicle.

If the air is sterilized, the breathing air in the cabin of the vehicle 100 may be cleaner, resulting in a better health environment for vehicle passengers. If the heat exchanger 120 efficiently transfers heat, and the fan efficiently moves air, less power is required for normal HVAC operation. An air conditioning compressor of a bus may require 25 to 55 h.p. during operation. If the heat exchanger 120 and the fan work efficiently, the operating time of an air conditioning compress may be reduced. Moreover, if the heat exchanger 120 and fan 115 remain clean, then a smaller heat exchanger 120 and smaller fan 115 may be selected for use in the HVAC system of the vehicle. If a smaller heat exchanger 120 and smaller fan 115 are used in the HVAC system, less power will be required to run the HVAC system. Therefore, fuel efficiency to operate the vehicle will be enhanced. Moreover, maintenance costs in cleaning the HVAC system may be saved.

The germicidal lamp 150 may be constructed of a glass tube. Glass tubing is known to be strong and stiff with regard to static tensile and compressive forces, but fragile with regard to sheer and torsion. Glass tubes tend to be fragile with regard to impacts and shaking. Glass tubes typically fail in a mode of fracture when subjected to impact or shaking.

However, it is not necessary that the germicidal lamp 150 be constructed of a hollow glass tube. Alternate constructions of the germicidal lamp 150 may include a composite material, a polymer or a plastic that is at least partially translucent to a germicidal spectrum of light. The alternate materials may provide greater resilience to impact and shaking.

Vibration refers to a periodic motion of a mass in alternately opposite directions from the position of equilibrium when that equilibrium has been disturbed, for example by a sinusoidal force. The mass may be the vehicle 100 itself, or anything installed in, attached to, carried by, or towed by the vehicle 110.

Shock refers to an impact as in a striking, an impinging, or a collision. Shock, physically characterized, is the reaction of the mass to the rate of change of an applied force.

As described below, forces, torsion, vibrations, and shock may occur during normal operation of the vehicle 100. Although glass tubing is durable with regard to static tensile and compressive forces, the cyclic vibrations may cause the glass tubing to fail prematurely. Moreover, a simple sheer shock or torsional shock may cause the glass tubing to fail at any time.

The germicidal lamp 150 may comprise other fragile components, susceptible to failure, such as a stem (described below), electrical contacts and electrical filaments. If the stem or the glass tubing fails, the vaporizable material, for example, mercury, may escape and cause environmental harm. Alternatively, if the electrical filament or the electrical contacts fail, the germicidal lamp 150 may cease emitting germicidal radiation. Moreover, if the forces, torsion, vibrations, or shock cause the germicidal lamp 150 to move relative to the vehicle 100, the germicidal lamp 150 may detach from it's mechanical support and electrical supply resulting in cessation of germicidal radiation emissions and possible mechanical failure.

Newton's first law states that a mass, such as the vehicle 100, will remain in a state of rest or will continue to move with constant velocity unless an unbalanced external force acts on it. For the germicidal lamp 150 to begin moving with the vehicle 100 from a state of rest, the vehicle 100 must exert a force on the germicidal lamp 150. For the germicidal lamp 150 to stop moving, the vehicle 100 must exert a force on the germicidal lamp 150.

As the vehicle 100 is loaded with cargo or passengers, or moves over bumps, potholes, or other irregularities in the road, the vehicle may bounce. As the vehicle 100 moves through a turn or maneuvers around an embankment, the vehicle 100 may roll. For the germicidal lamp 150 to move up and down and side to side along with the vehicle 100, the vehicle 100 must exert forces on the germicidal lamp 150.

As the engine of the vehicle 100 is running, the internal energy of the fuel, when combusted, is converted, at least in part, to kinetic energy of the engine. As the engine cycles, it will exert a force on the vehicle 100 causing the vehicle 100 to move. The motion of the vehicle 100 will result in forces applied to the germicidal lamp 150. The forces may be cyclic or vibratory. The forces may be complex and vary in terms of directions and frequencies.

For the germicidal lamp 150 to remain mounted to the vehicle 100, the velocity of the germicidal lamp 150 will be equal to the velocity of the vehicle 100, else the lamp would separate from the vehicle 100.

The vehicle 100 may stop abruptly, make an abrupt turn, or experience a quick motion of short duration. In order to make abrupt motions, or changes in position, and remain mounted to the vehicle 100, the germicidal lamp 150 will achieve velocities very quickly. In order to achieve velocities quickly, accelerations and jerk will be experienced by the germicidal lamp 150. Acceleration is related to the force applied by the vehicle 100. Jerk, the rate of change of the acceleration, is more commonly known as shock.

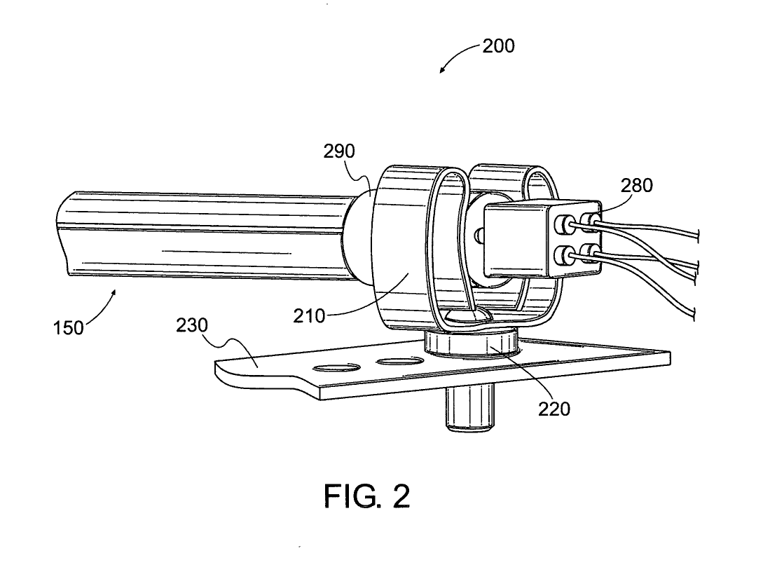

Referring now to FIG. 2, there is shown a first embodiment of a mounting apparatus 200 for reducing the effects of vibration and/or shock on the germicidal lamp 150. The mounting apparatus 200 may comprise a germicidal lamp 150, a clasp 210, a socket 280, a dampener 220, and a member 230 of a vehicle 100.

The germicidal lamp 150 may comprise a stem 290 for receiving mechanical support from the clasp 210 and electrical power from the socket 280. The stem 290 may attach to the socket 280 via industry standard pins such as a bi-pin, a single pin, a R17d, a medium bi-pin, a four pin, a 2Gx13, a recessed double contact, a G-23, or a 2G-11. The stem 290 may be a conduit for electrical components. The stem 290 may provide mechanical rigidity to the end of the germicidal lamp 150. The stem 290 may receive mechanical support from the socket 280.

The dimensions and shape of the stem 290 may vary due to the assembly size and weight constraints as well as power requirements. A common shape of a stem 290 is substantially hollow cylinder with one end attached to the glass tube. An alternate shape of a stem 290 may be a cube with beveled edges. The stem 290 may have a flange extending from the body of the cylinder. Common dimensions for a cylindrical stem 290 include, but are not limited to, a length of approximately 1¼ inches, and a diameter of approximately 3/4 of an inch. Common dimensions for a cubic stem 290 include, but are not limited to, an edge length of ¾ of an inch.

The socket 280 may receive mechanical support from the stem 290. The socket 280 may provide power to the stem 290. The socket 280 may be constructed of metal, plastic, ceramic, glass, or a composite material. The choice of material may be made based on the environment that the socket 280 will be exposed to. Examples of suitable materials for the housing 370 include, but are not limited to fiberglass, silica fiber, and ceramic.

A common socket for a germicidal lamp 150 may have a tombstone shape, and be approximately 1 inch in height, approximately 1 inch in width, and approximately ⅜^{th} inches in depth. However, the socket 280 may be similar in form to a cube with rounded edges having an edge length of approximately 1⅜^{th} inches. Alternatively, the socket 280 may take the form of a cylinder with a length of 2 inches and a diameter of ⅜^{th} of an inch.

The member 230 of the vehicle 100 may be the frame of the vehicle 100. The member 230 of the vehicle 100 may be a bracket that is attached via mechanical fastener, welding, adhesive, or magnet to the frame of the vehicle. The bracket may be an aluminum L-bracket, or a carbon fiber U-bracket. The fastener may be a screw, bolt, rivet, latch, pin, or other fastener. The adhesive may be a glue, cement, or other adhesive.

The member 230 of the vehicle 100 may comprise a metal, for example, aluminum, titanium, or stainless steel. The member 230 of the vehicle 100 may comprise a composite, such as fiberglass or carbon fiber. The member 230 of the vehicle 100 may comprise a plastic, for example PVC. The member 230 of the vehicle 100 may be rigid and strong such that the member of the vehicle may provide mechanical support to the clasp 210.

The clasp 210 may provide mechanical support to the stem 290. The clasp 210 may affix to the member 230 of the vehicle 100 via a fastener, a welding, a magnet, or an adhesive. Alternatively, the clasp 210 may affix to the member 230 of the vehicle 100 via a flange, bracket, or other fixed surface of the vehicle. The clasp 210 may take the form of one of or combinations of a spring clamp, a sleeve, a hanger, a race, a locking clamp, a clip, a holster, and a strap. The clasp 210 may at least partially surround the stem 290. Alternatively, the clasp 210 may at least partially surround both the stem 290 and the socket 280. The clasp 210 may comprise a material that is resistant to heat and environmental elements.

An example of the clasp 210 is a stamped aluminum spring clip with a hard plastic coating. The clasp 210 of FIG. 2 is a common spring clip which may secure a ¾^{th} inch diameter stem. The common spring clip may have bent surfaces that contact the stem 290 in 30 degree arcs, ⅝^{th} of an inch in width, on opposite sides of the stem 290. Alternatively, the spring clip may be formed to contact the stem 290 in 60 degree arcs, ⅜^{th} of an inch in width, on opposite sides of the stem 290. Another example of the clasp 210 is a composite rigid sleeve. Moreover, the clasp 210 may be a stainless steel locking clamp with neoprene teeth.

The dampener 220 may be disposed between the member 230 of the vehicle 100 and the clasp 210. The dampener 220 may abut the clasp 210. The dampener 220 may abut the member 230 of the vehicle 100.

The dampener 220 is an element used to dampen vibration and or shock. Dampen refers to an effect that diminishes or reduces the amplitude or intensity of vibration or shock over a period of time. The dampener 220 is an element of a system that causes dampening. Dampening may occur rapidly or progressively.

Dampening is typically the result of viscosity or friction. However, dampening may result from elastic deformation of a solid. Alternatively, dampening may result from a conversion of kinetic or potential energy to internal energy, heat energy, or even a chemical reaction.

The dampener 220 may take the form of one of or combinations of a dampening sheet, a cushion pad, a bushing, a grommet, a washer, a spring, a shock, a bumper, a foam tape, a gasket and a dampening tape. The dampener 220 may comprise a material such as a rubber, a plastic, an elastomer, a foam, a composite, a fabric, and a lead/fiberglass sheet. The dampener 220 may be a dampening adhesive. The dampener 220 may be selected based on its dampening properties and the vibration and/or shock that the germicidal lamp 150 will be subject to.

An example of the dampener 220 is a Well-Nut bushing. The Well-Nut bushing comprises a flanged neoprene bushing with a threaded nut molded into one end. Tightening a conventional machine screw threaded into the nut causes the insert to deform and become preloaded as a dampener. If a Well-Nut style bushing is used in combination with the fastener of the clasp 210 to the member 230 of the vehicle 100, the deformed bushing may provide both dampening and a more secure affixation. Another example of the dampener 220 is neoprene washer. Moreover, the dampener 220 may be a sponge rubber grommet. The dampener 220 may dampen vibration and/or shock that the germicidal lamp 150 may be subject to.

The stem 290 may comprise a dampening material or be at least partially coated with a dampening material. Alternatively, the stem 290 may be at least partially surrounded by a dampening material (not shown). Moreover, the stem 290 may include dampening surface ribs, for example, neoprene strips. A dampening material may include, but is not limited to a neoprene rubber, a gum rubber, a sponge rubber, an E.P.M.D. rubber, a nitrile rubber, an S.B.R. rubber, a plastic, an elastomer, a foam, a composite, a fabric, and a lead/fiberglass sheet.

Additionally, the clasp 210 may comprise a dampening material or may be coated with a dampening material.

Moreover, an additional dampener may be disposed between the member of the vehicle 100 and the vehicle 100.

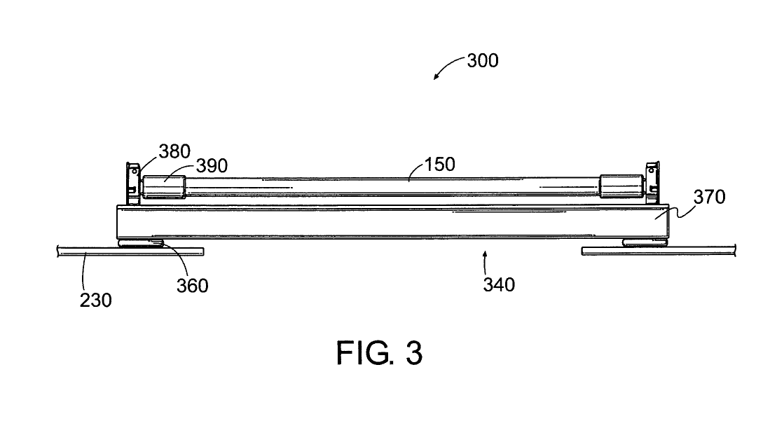

Referring now to FIG. 3, there is shown a second embodiment of a mounting apparatus 300 for reducing the effects of vibration and/or shock on the germicidal lamp 150. The mounting apparatus 300 may comprise a germicidal assembly 340, a member 230 of a vehicle 100, and a first dampener 360.

The germicidal assembly 340 may comprise a housing 370, a germicidal lamp 150, and a socket 380. The germicidal assembly 340 may be adapted to affix to the member 230 of the vehicle 100 and provide mechanical support to the germicidal lamp 150. The housing 370 may be rigid. The housing 370 may be constructed of metal, plastic, ceramic, or glass. The housing 370 material may be a composite material. The choice of material may be made based on the environment that the housing 370 will be exposed to. For example, if the housing 370 will be subject to a very hot environment, a titanium material may be selected for light weight and resistance to heat. Alternatively, if the housing 370 will be in a moderate environment PVC may be and appropriate light weight material.

The socket 380 may be attached to the housing 370 via a fastener, welding, brazing, adhesive, or magnet. The socket 380 may be integral to the housing 370. Alternatively, the socket 380 may be attached to the housing 370 via a flange or a bracket. The structure in attaching the socket 380 to the housing 370 may be selected based on strength, durability, light weight, and resistance to environmental elements. The socket 380 may attach to the housing 370 via a plastic clip integral to the socket 380 which affixes to the housing 370 though a groove in the housing 370. The socket 380 may provide mechanical support and electrical power to the stem 390 of the germicidal lamp 150.

The first dampener 360 may be disposed between the housing 370 and the member 230 of the vehicle 100. The first dampener 360 may abut the housing 370. The first dampener 360 may abut the member 230 of the vehicle 100. The material and form of the first dampener 360 may be selected based on its dampening properties and the vibration and/or shock that the germicidal lamp 150 will be subject to.

An example of the first dampener 360 is a washer comprising a cellular padded material. The washer may take the form of an annular ring with an outer diameter of 3 inches, an inner diameter of 3/16^{th} of an inch, and a thickness of 1 inch. Another example of the first dampener 360 is an isolated air shock assembly. Moreover, the first dampener 360 may be a neoprene bumper.

The housing 370 may be affixed to the member 230 of the vehicle 100 via a fastener. Alternatively, the housing 370 may be affixed to the member 230 of the vehicle 100 via an adhesive. The housing 370 may be affixed to the member 230 of the vehicle 100 via a bracket, flange, or other mechanical support. Moreover, the housing 370 may be magnetically secured to the member 230 of the vehicle 100. The housing 370 may be affixed to the member 230 of the vehicle 100 to provide mechanical support to the germicidal assembly 340.

The germicidal assembly 340 may comprise a second dampener (not shown). The second dampener may be disposed between the stem 390 and the socket 380. The second dampener may be disposed between the socket 380 and the housing 370. The form and material of the second dampener (not shown) may be selected based on its dampening properties and the vibration and/or shock that the germicidal lamp 150 will be subject to.

An example of the second dampener (not shown) may be a shrink sleeve plastic that conforms to an electrical pin of the stem 390. Alternatively, the second dampener (not shown) may be a double sided foam tape affixing the socket 380 to a flange. Moreover, the second dampener (not shown) may be a molded plastic spring disposed between the stem 290 and the socket 380, abutting both the stem 390 and the socket 380.

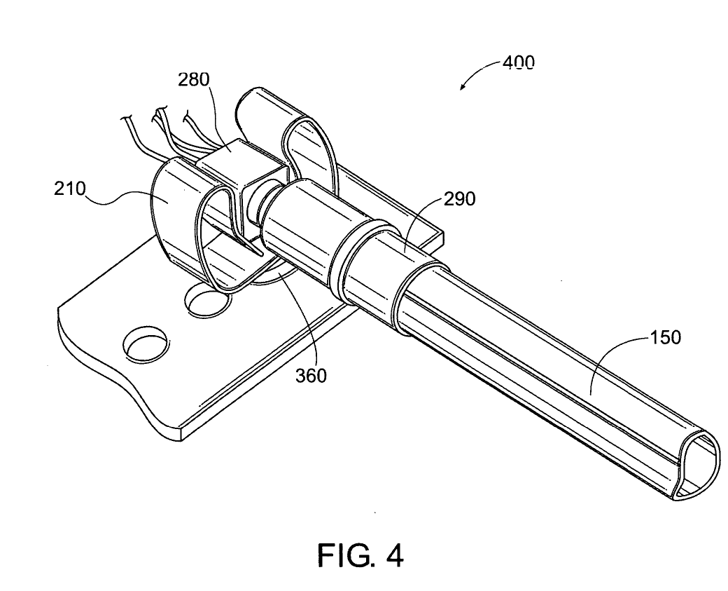

Referring now to FIG. 4, there is shown a third embodiment of a mounting apparatus 400 for reducing the effects of vibration and/or shock on the germicidal lamp 150. The mounting apparatus 400 may comprise a germicidal lamp 150, a clasp 210, a socket 280, a first dampener 360, and a member 230 of a vehicle 100.

As shown, the clasp 210 may provide mechanical support to the socket 280. The socket 280 may comprise a dampening material or be at least partially coated with a dampening material. The clasp 210 may affix to the member 230 of the vehicle 100. The first dampener 360 may be disposed between the member 230 of the vehicle 100 and the clasp 210.

The mounting apparatus 400 may comprise a second dampener (not shown). An example of the second dampener (not shown) may be a foam tape that wraps an electrical pin of the stem 290. Moreover, the second dampener (not shown) may be a soft gum globe compressed between the stem 290 and the socket 280.

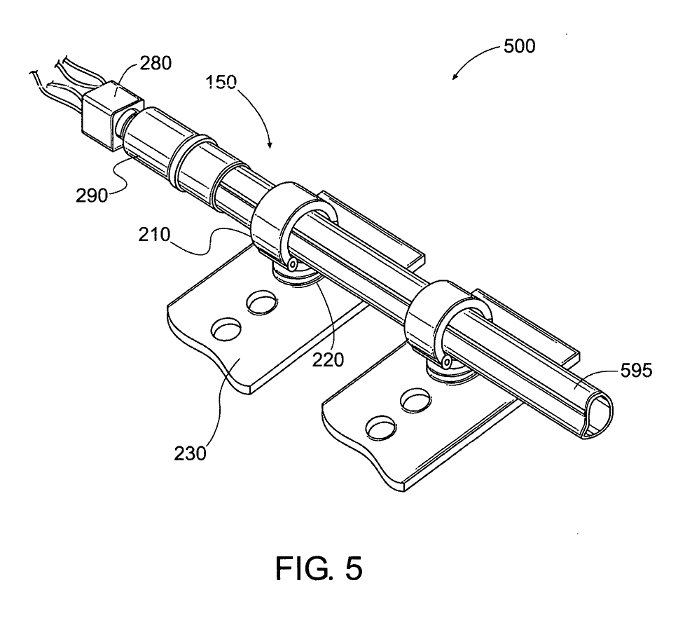

Referring now to FIG. 5, there is shown a fourth embodiment of a mounting apparatus 500 for reducing the effects of vibration and/or shock on the germicidal lamp 150. The mounting apparatus 500 comprises a germicidal lamp 150, a clasp 210, a socket 280, a dampener 220, and a member 230 of a vehicle 100.

The germicidal lamp comprises an envelope 595, attached to the stem 290, for housing a vaporizable material that emits radiation when energized. The envelope 595 may have a cross sectional shape of a circle, oval, tetrahedron, pentagon, hexagon, octagon or other shape. The material for the envelope 595 may be selected based on translucency of radiation of germicidal wavelengths.

The clasp 210 may provide mechanical support to the envelope 595. The envelope 595 may comprise a dampening material or be at least partially coated with a dampening material at a section where the clasp 210 provides mechanical support to the envelope 595. For example, the envelope may have a foam coating, 20 mm wide and 30 mm thick, which covers 270 degrees of a circumference of the envelope 595 where the envelope 595 has a circular cross section. Alternatively, the envelope may have a ethylene propylene rubber coating, 15 mm wide and 15 mm thick, which surrounds an entire cross section of the envelope 595 where the envelope 595 has an oval cross section.

The clasp 210 may affix to the member 230 of the vehicle 100 via a fastener, a welding, magnet, or an adhesive. An example of the clasp 210 is stamped copper-nickel alloy spring clip with a chlorinated rubber coating. Another example of the clasp 210 is a composite rigid sleeve. Moreover, the clasp 210 may be a fiberglass mesh strap. The clasp 210 may be affixed to the member 230 of the vehicle 100 such that the position of the germicidal lamp 150 allows for emission of radiation to the heat exchanger 120.

The dampener 220 may be disposed between the member 230 of the vehicle 100 and the clasp 210. The form and material of the dampener 220 may be selected based on its dampening properties and the vibration and/or shock that the germicidal lamp 150 will be subject to. An example of the dampener 220 is an RTV bead. Alternatively, the dampener 220 may be a styrene butadiene rubber grommet.

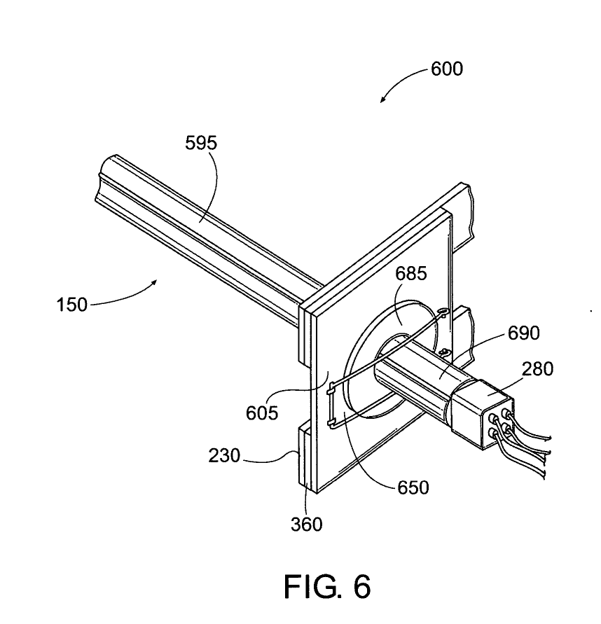

Referring now to FIG. 6, there is shown a fifth embodiment of a mounting apparatus 600 for reducing the effects of vibration and/or shock on the germicidal lamp 150. The mounting apparatus 600 comprises germicidal lamp 150, a member 230 of a vehicle 100, a mounting base 605, a clasp 650, and a first dampener 360. The stem 690 may comprise a flange 685 which receives mechanical support from both the mounting base 605 and the clasp 650.

The mounting base 605 may comprise a rigid material, for example steel, aluminum, fiberglass, a composite, wood, or other material selected for strength, durability, and resistance to environmental elements. The mounting base 605 may be affixed to the member 230 of the vehicle via a fastener, welding, magnet, or adhesive.

The mounting base 605 may take the form of a ⅛^{th} inch thin rectangular metal sheet with a hole, larger than the largest cross section of the envelope 595, but smaller than the cross section of the flange 685. Alternatively, the mounting base 605 may take the form of an irregular shape comprising many bends and a hole, larger than the largest cross section of the envelope 595, but smaller than the cross section of the flange 685. The hole may take the shape of a circle, an oval, a rectangle, an octagon, a decahedron, or other. The hold need only allow the envelope 595 to pass through, but not the flange 685. An example of a mounting base 605 is a 1/16^{th} inch thick square titanium plate with a 1½ inch circular hole in the center of the mounting base 605.

The envelope 595 may be adapted to pass through the hole of the mounting base 605 and the flange 685 may be adapted to be secured to the mounting base via the clasp 650. The clasp 650 may be affixed to the mounting base 605 via a fastener, hinge, welding, magnet, or adhesive. The clasp 650 may take the form of one of or combinations of a spring clamp, a locking clamp, a clip, and a strap. The clasp 650 may comprise a material that is resistant to heat and environmental elements. The clasp 650 may comprise a dampening material or may be coated with a dampening material. The clasp 650 need only provide a force against the flange 685 such that the flange 685 is secured by both the clasp 650 and the mounting base 605.

The first dampener 360 may be disposed between the mounting base 605 and the member 230 of the vehicle 100. The form and material of the first dampener 360 may be selected based on its dampening properties and one of or combinations of vibration, shock, and jerk that the germicidal lamp 150 will be subject to.

An example of the first dampener 360 is a cellular padded material adhesively attached to an entire surface of the mounting base 605. Another example of the first dampener 360 is heat exchanger spring. Moreover, the first dampener 360 may be a silicone bumper.

The mounting apparatus 600 may comprise a second dampener (not shown). The second dampener (not shown) may be disposed between the clasp 650 and the flange 685. The form and material of second dampener (not shown) may be selected based on its dampening properties and the vibration and/or shock that the germicidal lamp 150 will be subject to.

An example of the second dampener (not shown) may be an high temperature RTV silicone bead disposed between the flange 685 and the mounting base 605. Alternatively, the second dampener (not shown) may be a hard rubber half globe disposed between the clasp 650 and the flange 685.

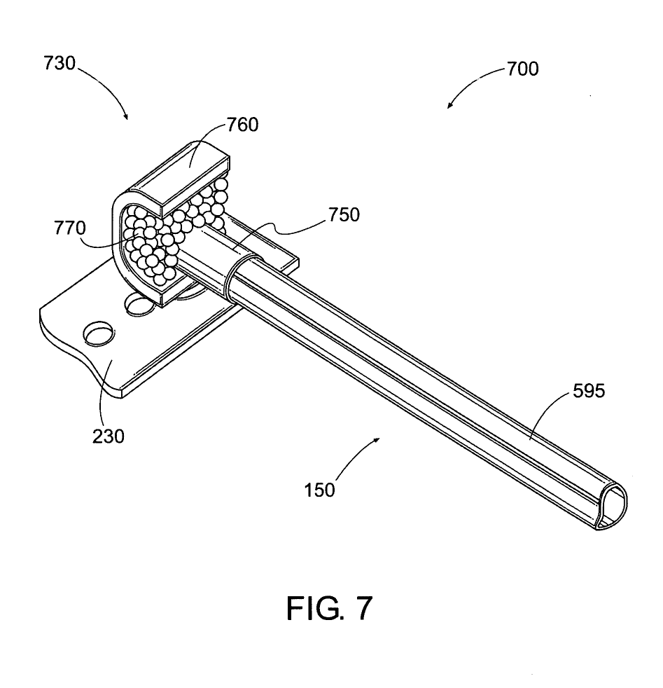

The germicidal lamp 150 of FIG. 6 may be a single ended lamp which receives mechanical support and electrical power from only one socket 280. Referring now to FIG. 7, there is shown a sixth embodiment of a mounting apparatus 700 for reducing the effects of vibration and/or shock on the germicidal lamp 150.

The mounting apparatus 700 comprises germicidal lamp 150, a member 230 of a vehicle 100, and a mount 730. The germicidal lamp 150 comprises an end cap 750 attached to the envelope 595. The primary use for the end cap 750 is not for mechanical mounting nor receiving electrical power. The mounting apparatus may comprise a nest dampener 760 for providing dampening to the germicidal lamp 150.

The nest dampener 760 may comprise a dampening material 770 adapted to at least partially surround the end cap 750. The dampening material 770 may be adapted to completely surround the end cap 750. The dampening material 770 may be attached to a mount 730 via an adhesive such as a glue, cement, or double sided tape. The dampening material 770 may be a composite that is integral to the mount 730. The mount 730 may be attached to a member of the vehicle via a fastener, a welding, a magnet, or an adhesive.

An example of a nest dampener 760 is a half-globe foam cushion pad adhesively attached to a pitch-fork shaped magnetic mount 730. Another example of a nest dampener 760 is a cellular cushion pad comprising a threaded hole for a fastener for affixing to the member 230 of the vehicle 100. Moreover, the nest dampener 760 may have a hard composite open ended pyramid shaped mount 730 that houses a dampening material 770 which is an elastic polymer encapsulating a viscous fluid such as glycerin which conforms to the shape of the end cap 750.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

1. A mounting apparatus for mounting a germicidal system in a vehicle, the germicidal system comprising a lamp having a stem, the mounting apparatus comprising:
a fixture comprising
a housing providing mechanical support to the germicidal lamp, wherein the housing is adapted to affix to a member of the vehicle
a socket for supporting the germicidal lamp, wherein the socket is affixed to the housing
a first dampener for reducing an effect selected from the group comprising vibration and shock, abutting the housing, wherein the first dampener is adapted to abut the member of the vehicle.

2. The mounting apparatus for mounting a germicidal system in a vehicle of claim 1, further comprising a second dampener selected from the group comprising a dampening sheet, a cushion pad, a bushing, a grommet, a washer, a spring, a shock, a bumper, a foam tape, a gasket and a dampening tape, at least partially disposed between the stem and the socket.

3. The mounting apparatus for mounting a germicidal system in a vehicle of claim 1, further comprising a second dampener selected from the group comprising a dampening sheet, a cushion pad, a bushing, a grommet, a washer, a spring, a shock, a bumper, a foam tape, a gasket and a dampening tape, at least partially disposed between the socket and the housing.

4. The mounting apparatus for mounting a germicidal system in a vehicle of claim 1, wherein the housing is further adapted to affix to the member of the vehicle with a magnet.

5. The mounting apparatus for mounting a germicidal system in a vehicle of claim 1, wherein the housing is further adapted to affix to the member of the vehicle with an adhesive.

6. The mounting apparatus for mounting a germicidal system in a vehicle of claim 4, wherein the magnet comprises a dampening material.

7. The mounting apparatus for mounting a germicidal system in a vehicle of claim 5, wherein the adhesive comprises a dampening material.

8. The mounting apparatus for mounting a germicidal system in a vehicle of claim 1, wherein the first dampener is selected from the group comprising a dampening sheet, a cushion pad, a bushing, a grommet, a washer, a spring, a shock, a bumper, a foam tape, a gasket and a dampening tape.

9. The mounting apparatus for mounting a germicidal system in a vehicle of claim 8, wherein the first dampener comprises a material selected from the group comprising a rubber, a plastic, an elastomer, a foam, a composite, a fabric, and a lead/fiberglass.

10. A mounting apparatus for mounting a germicidal system in a vehicle, the germicidal system comprising a lamp having a stem, the mounting apparatus comprising:
a clasp for supporting the stem, wherein the clasp is adapted to affix to a member of a vehicle
a dampener for reducing an effect selected from the group comprising vibration and shock, abutting the clasp, wherein the dampener is adapted to abut the member of the vehicle.

11. The mounting apparatus for mounting a germicidal system in a vehicle of claim 10, wherein the stem is at least partially coated with a dampening material.

12. The mounting apparatus for mounting a germicidal system in a vehicle of claim 10, wherein the stem is at least partially surrounded by one selected from the group comprising a dampening sheet, a cushion pad, a bushing, a grommet, a washer, a spring, a shock, a bumper, a foam tape, a gasket and a dampening tape.

13. The mounting apparatus for mounting a germicidal system in a vehicle of claim 10, wherein the clasp is selected from the group comprising a spring clamp, a sleeve, a hanger, a race, a locking clamp, a clip, a holster, and a strap.

14. The mounting apparatus for mounting a germicidal system in a vehicle of claim 10, wherein the clasp comprises a dampening material.

15. The mounting apparatus for mounting a germicidal system in a vehicle of claim 10, wherein the clasp is further adapted to affix to the member of the vehicle with a fastener.

16. The mounting apparatus for mounting a germicidal system in a vehicle of claim 10, wherein the clasp is further adapted to affix to the member of the vehicle via a magnet.

17. The mounting apparatus for mounting a germicidal system in a vehicle of claim 10, wherein the clasp is further adapted to affix to the member of the vehicle with an adhesive.

18. The mounting apparatus for mounting a germicidal system in a vehicle of claim 15, wherein the fastener comprises a dampening material.

19. The mounting apparatus for mounting a germicidal system in a vehicle of claim 17, wherein the adhesive comprises a dampening material.

20. The mounting apparatus for mounting a germicidal system in a vehicle of claim 10, wherein the dampener is selected from the group comprising a dampening sheet, a cushion pad, a bushing, a grommet, a washer, a spring, a shock, a bumper, a foam tape, a gasket and a dampening tape.

21. The mounting apparatus for mounting a germicidal system in a vehicle of claim 20, wherein the dampener comprises a material selected from the group comprising a rubber, a plastic, an elastomer, a foam, a composite, a fabric, and a lead/fiberglass.

22. A mounting apparatus for mounting a germicidal system in a vehicle, the germicidal system comprising a lamp having a stem, the mounting apparatus comprising:
a socket for mechanically supporting and electrically powering the stem
a clasp for supporting the socket, wherein the clasp is adapted to affix to a member of a vehicle
a first dampener for reducing an effect selected from the group comprising vibration and shock, abutting the clasp, wherein the first dampener is adapted to abut the member of the vehicle.

23. The mounting apparatus for mounting a germicidal system in a vehicle of claim 22, wherein the socket is at least partially coated with a dampening material.

24. The mounting apparatus for mounting a germicidal system in a vehicle of claim 22, wherein the socket is at least partially surrounded by one selected from the group comprising a dampening sheet, a cushion pad, a bumper, a foam tape, and a dampening tape.

25. The mounting apparatus for mounting a germicidal system in a vehicle of claim 22, wherein the clasp is selected from the group comprising a spring clamp, a sleeve, a hanger, a race, a locking clamp, a clip, a holster, and a strap.

26. The mounting apparatus for mounting a germicidal system in a vehicle of claim 22, wherein the clasp comprises a dampening material.

27. The mounting apparatus for mounting a germicidal system in a vehicle of claim 22, wherein the clasp is further adapted to affix to the member of the vehicle with a fastener.

28. The mounting apparatus for mounting a germicidal system in a vehicle of claim 22, wherein the clasp is further adapted to affix to the member of the vehicle via a magnet.

29. The mounting apparatus for mounting a germicidal system in a vehicle of claim 22, wherein the clasp is further adapted to affix to the member of the vehicle with an adhesive.

30. The mounting apparatus for mounting a germicidal system in a vehicle of claim 27, wherein the fastener comprises a dampening material.

31. The mounting apparatus for mounting a germicidal system in a vehicle of claim 29, wherein the adhesive comprises a dampening material.

32. The mounting apparatus for mounting a germicidal system in a vehicle of claim 22, wherein the first dampener is selected from the group comprising a dampening sheet, a cushion pad, a bushing, a grommet, a washer, a spring, a shock, a bumper, a foam tape, a gasket and a dampening tape.

33. The mounting apparatus for mounting a germicidal system in a vehicle of claim 22, wherein the first dampener comprises a material selected from the group comprising a rubber, a plastic, an elastomer, a foam, a composite, a fabric, and a lead/fiberglass.

34. The mounting apparatus for mounting a germicidal system in a vehicle of claim 22, further comprising a second dampener selected from the group comprising a dampening sheet, a cushion pad, a bushing, a grommet, a washer, a spring, a shock, a bumper, a foam tape, a gasket and a dampening tape, at least partially disposed between the stem and the socket.

35. The mounting apparatus for mounting a germicidal system in a vehicle of claim 22, wherein the clasp is for supporting the socket and the stem.

36. A mounting apparatus for mounting a germicidal system in a vehicle, the germicidal system comprising a lamp having an envelope, the mounting apparatus comprising:
a clasp for supporting the envelope, wherein the clasp is adapted to affix to a member of a vehicle
a dampener for reducing an effect selected from the group comprising vibration and shock, abutting the clasp, wherein the dampener is adapted to abut the member of the vehicle.

37. The mounting apparatus for mounting a germicidal system in a vehicle of claim 36, wherein the envelope is at least partially coated with a dampening material.

38. The mounting apparatus for mounting a germicidal system in a vehicle of claim 36, wherein the envelope is at least partially surrounded by one selected from the group comprising a dampening sheet, a cushion pad, a bumper, a foam tape, and a dampening tape.

39. The mounting apparatus for mounting a germicidal system in a vehicle of claim 36, wherein the clasp is selected from the group comprising a spring clamp, a sleeve, a hanger, a race, a locking clamp, a clip, a holster, and a strap, or combinations therein.

40. The mounting apparatus for mounting a germicidal system in a vehicle of claim 36, wherein the clasp comprises a dampening material.

41. The mounting apparatus for mounting a germicidal system in a vehicle of claim 36, wherein the clasp is further adapted to affix to the member of the vehicle with a fastener.

42. The mounting apparatus for mounting a germicidal system in a vehicle of claim 36, wherein the clasp is further adapted to affix to the member of the vehicle via a magnet.

43. The mounting apparatus for mounting a germicidal system in a vehicle of claim 36, wherein the clasp is further adapted to affix to the member of the vehicle with an adhesive.

44. The mounting apparatus for mounting a germicidal system in a vehicle of claim 41, wherein the fastener comprises a dampening material.

45. The mounting apparatus for mounting a germicidal system in a vehicle of claim 43, wherein the adhesive comprises a dampening material.

46. The mounting apparatus for mounting a germicidal system in a vehicle of claim 36, wherein the dampener is selected from the group comprising a dampening sheet, a cushion pad, a bushing, a grommet, a washer, a spring, a shock, a bumper, a foam tape, a gasket and a dampening tape.

47. The mounting apparatus for mounting a germicidal system in a vehicle of claim 36, wherein the dampener comprises a material selected from the group comprising a rubber, a plastic, an elastomer, a foam, a composite, a fabric, and a lead/fiberglass.

48. A mounting apparatus for mounting a germicidal system in a vehicle, the germicidal system comprising a lamp having a stem, the stem having a flange, the mounting apparatus comprising:
a mounting base comprising an opening adapted to pass an envelope of the germicidal lamp, wherein the mounting base is adapted to affix to a member of a vehicle
a clasp for securing the flange to the mounting base, wherein the clasp is attached to the mounting base
a first dampener for reducing an effect selected from the group comprising vibration and shock, abutting the mounting base, wherein the first dampener is adapted to abut the member of the vehicle.

49. The mounting apparatus for mounting a germicidal system in a vehicle of claim 48, further comprising a second dampener selected from the group comprising a dampening sheet, a cushion pad, a bushing, a grommet, a washer, a spring, a shock, a bumper, a foam tape, a gasket and a dampening tape, at least partially disposed between the flange and the mounting base.

50. The mounting apparatus for mounting a germicidal system in a vehicle of claim 48, further comprising a second dampener selected from the group comprising a dampening sheet, a cushion pad, a bushing, a grommet, a washer, a spring, a shock, a bumper, a foam tape, a gasket and a dampening tape, at least partially disposed between the clasp and the mounting base.

51. The mounting apparatus for mounting a germicidal system in a vehicle of claim 48, further comprising a second dampener selected from the group comprising a cushion pad, a bushing, a grommet, a washer, a spring, a shock, a bumper, a foam tape, and a gasket, at least partially disposed between the flange and the mounting base.

52. The mounting apparatus for mounting a germicidal system in a vehicle of claim 48, wherein the mounting base is further adapted to affix to the member of the vehicle with a fastener.

53. The mounting apparatus for mounting a germicidal system in a vehicle of claim 48, wherein the mounting base is further adapted to affix to the member of the vehicle via a magnet.

54. The mounting apparatus for mounting a germicidal system in a vehicle of claim 48, wherein the mounting base is further adapted to affix to the member of the vehicle with an adhesive.

55. The mounting apparatus for mounting a germicidal system in a vehicle of claim 52, wherein the fastener comprises a dampening material.

56. The mounting apparatus for mounting a germicidal system in a vehicle of claim 54, wherein the adhesive comprises a dampening material.

57. The mounting apparatus for mounting a germicidal system in a vehicle of claim 48, wherein the first dampener is selected from the group comprising a dampening sheet, a cushion pad, a bushing, a grommet, a washer, a spring, a shock, a bumper, a foam tape, a gasket and a dampening tape.

58. The dampening assembly for a germicidal system of claim 48, wherein the first dampener comprises a material selected from the group comprising a rubber, a plastic, an elastomer, a foam, a composite, a fabric, and a lead/fiberglass.

59. The dampening assembly for a germicidal system of claim 48, further comprising an end cap of the germicidal lamp, a nest dampener at least partially surrounding the end cap, wherein the nest dampener comprises a dampening material and the nest dampener is adapted to affix to a second fixed surface of the vehicle.

60. The dampening assembly for a germicidal system of claim 59, wherein the dampening material of the nest dampener is selected from the group comprising a cushion pad, a bumper, a foam tape, a rubber, a plastic, an elastomer, a foam, a composite, a fabric, a cellular material, and a lead/fiberglass.
